(19) United States
(12) Patent Application Publication
(10) Pub. No.: US 2013/0013669 A1
(43) Pub. Date: Jan. 10, 2013

(54) METHOD AND APPARATUS FOR GUARANTEEING WEB-BASED MOBILITY

(75) Inventors: Sun-Sim CHUN, Daejeon-si (KR); Young-Il KIM, Daejeon-si (KR); Yang-Jung KIM, Seoul (KR); Il-Young CHONG, Seongnam-si (KR)

(73) Assignees: Hankuk University Of Foreign Studies Research and Industry-University Cooperation Foundation, Yongin-si (KR); Electronics and Telecommunications Research Institute, Daejeon-si (KR)

(21) Appl. No.: 13/533,427

(22) Filed: Jun. 26, 2012

(30) Foreign Application Priority Data
Jul. 6, 2011 (KR) 10-2011-0066975

(51) Int. Cl. G06F 15/16

(52) U.S. Cl. 709/203

(57) ABSTRACT

A web-based mobility guaranteeing method includes, at a terminal, connecting to a first service providing apparatus; transmitting a service request signal for requesting service information to the first service providing apparatus; at the first service providing apparatus, transmitting a service providability inquiry signal to a web-based service providing apparatus, based on whether or not the service information is able to be provided by the first service providing apparatus; at the web-based service providing apparatus, transmitting the service providability inquiry signal to a second service providing apparatus, receiving a service providability response signal from the second service providing apparatus, and changing a service provider of the terminal from the first service providing apparatus to the second service providing apparatus; and at the terminal, receiving a service response signal from the second service providing apparatus in response to the service request signal.

### CROSS-REFERENCE TO RELATED APPLICATION

This application claims the benefit under 35 U.S.C. §119(a) of a Korean Patent Application No. 10-2011-0066975, filed on Jul. 6, 2011, the entire disclosure of which is incorporated herein by reference for all purposes.

### BACKGROUND

1. Field

The following description relates to a method and apparatus for guaranteeing web-based mobility, and more particularly, to a method and apparatus for guaranteeing web-based mobility, capable of providing service information requested on web by a user to the user's terminal, regardless of a service provider and a dedicated network, instead of providing the user's terminal with only limited service information from a service provider in which the user's terminal has been registered.

2. Description of the Related Art

According to a conventional process in which a terminal requests specific service information, the terminal performs a basic call procedure and a security/authentication procedure that are provided through a dedicated network of a service provider, and requests service information that is provided by the service provider. Then, the service provider transmits the requested service information to the terminal.

However, in the conventional process, the terminal receives only limited service information from the service provider of the dedicated network for which the terminal has performed call setting. However, in order to provide customized services, it is necessary to provide a user's desired service information from service providers of heterogeneous networks, as well as from service providers in which the user's terminal has been registered.

### SUMMARY

The following description relates to a method and apparatus for guaranteeing web-based mobility, capable of providing service information requested on web by a user to the user's terminal, regardless of a service provider and a dedicated network.

In one general aspect, there is provided a web-based mobility guaranteeing method comprising: at a terminal, connecting to a first service providing apparatus; at the terminal, transmitting a service request signal for requesting service information to the first service providing apparatus; at the first service providing apparatus, transmitting a service providability inquiry signal to a web-based service providing apparatus, based on whether or not the service information is able to be provided by the first service providing apparatus; at the web-based service providing apparatus, transmitting the service providability inquiry signal to a second service providing apparatus that is determined to be an apparatus capable of providing the service information, receiving a service providability response signal from the second service providing apparatus, and then changing a service provider of the terminal from the first service providing apparatus to the second service providing apparatus; and at the terminal, receiving a service response signal from the second service providing apparatus in response to the service request signal.

In another general aspect, there is provided a web-based service providing apparatus comprising: a communication unit configured to receive a service providability inquiry signal from a first service providing apparatus; a service apparatus checking unit configured to determine which apparatus is able to provide service information corresponding to the service providability inquiry signal; a service providability checking unit configured to transmit the service providability inquiry signal to a second service providability apparatus that is determined to be an apparatus capable of providing the service information, and to receive a service providability response signal from the second service providing apparatus in response to the service providability inquiry signal; and a service apparatus changing unit configured to change a service provider of the terminal from the first service providing apparatus to the second service providing apparatus.

In another general aspect, there is provided a service providing apparatus comprising: a first connecting unit configured to connect to a terminal; a first signal receiver configured to receive a service request signal for requesting service information from the terminal; a first service providability checking unit configured to transmit a service providability inquiry signal to a web-based service providing apparatus, based on whether or not the service information is able to be provided, and to receive a service providability response signal from the web-based service providing apparatus in response to the service providability inquiry signal; and a first disconnecting unit configured to be disconnected from the terminal according to the service providability response signal.

Other features and aspects will be apparent from the following detailed description, the drawings, and the claims.

### BRIEF DESCRIPTION OF THE DRAWINGS

FIG. 1 schematically shows an example of a web-based mobility guaranteeing system.

FIG. 2 is a diagram illustrating an example of a web-based service providing apparatus.

FIG. 3 is a diagram illustrating an example of a first service providing apparatus.

FIG. 4 is a diagram illustrating an example of a second service providing apparatus.

FIG. 5 is a flowchart illustrating an example of a web-based mobility guaranteeing method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The term “service-based handoff” mentioned in an example is defined as follows. General handoff is a method of removing service disruption in a wireless region due to movement speed of a terminal 110 to ensure a seamless service, whereas service-based handoff is a method of providing service information requested by the terminal 110 as an independent service without being dependent on a network to which the terminal 110 belongs, regardless of a wireless channel state of the terminal 110. That is, when service-based handoff is performed, the terminal 110 can receive web-based service information that is provided by service providers of heterogeneous networks, as well as service information that is provided by a service provider of a network in which the terminal 110 has been registered.

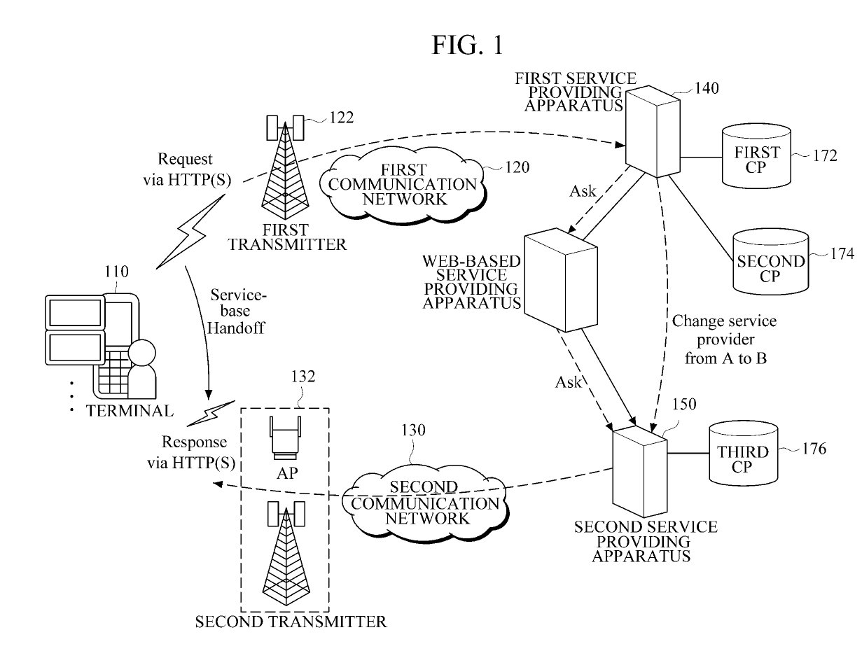

FIG. 1 schematically shows an example of a web-based mobility guaranteeing system.

The web-based mobility guaranteeing system includes a terminal 110, a first communication network 120, a first transmitter 122, a second communication network 130, a second transmitter 132, a first service providing apparatus 140, a second service providing apparatus 150, a web-based service providing apparatus 160, a first Content Provider (CP) 172, a second CP 174, and a third CP 176. However, the above-mentioned components of the web-based mobility guaranteeing system can be combined in a different manner and/or replaced or supplemented by other components or their equivalents within the scope of the present invention.

The terminal 110 is a terminal that can receive or transmit various data through the first communication network 120 or the second communication network 130 according to a user's key manipulation. The terminal 110 may be one of a tablet PC, a Laptop, a Personal Computer (PC), a smart phone, a Personal Digital Assistant (PDA), and a mobile communication terminal. Also, the terminal 110 may be a cloud computing terminal that supports cloud computing to read/write/store data or use network services, content, etc. through the first communication network 120 or the second communication network 130.

That is, the terminal 110 is a terminal that performs voice calls or data communication through the first communication network 120 or the second communication network 130, wherein the terminal 110 includes a memory for storing a browser and a program for connecting to the first service providing apparatus 140 or the second service providing apparatus 150 through the first communication network 120 or the second communication network 130, a microprocessor for executing programs to perform computation and control operations, etc. That is, the terminal 110 is an arbitrary terminal capable of performing server-client communication with the first or second service providing apparatus 140 or 150, and includes a communication computing device, such as a notebook computer, a mobile communication terminal, a PDA, etc. Meanwhile, the terminal 110 may be designed to include a touch screen. In the following description, the terminal 110 is implemented as a separate apparatus from the web-based service providing apparatus 160, however, in actual implementation, the terminal 110 may be implemented as a Stand Alone apparatus that has some or all functions of the web-based service providing apparatus 160.

The terminal 110 drives an application that requests a specific service according to a user's manipulation or instruction and may output service information received through the corresponding application. Meanwhile, the application is, if the terminal 110 is a smart phone, downloaded through an application store and then installed, and if the terminal 110 is a feature phone, the application is driven on a Virtual Machine (VM) downloaded through the first or second service providing apparatus 140 or 150.

According to an example, the terminal 110 is a terminal that supports a mobile IPTV (Internet Protocol Television).

A web-based mobile IPTV service is an open service that uses various intelligent web technologies, such as Semantic, Mash-UP, Wiki, RSS, Ontology, XaaS, etc., and the open service can be provided between heterogeneous service providers. A mobile user may use service-based handoff through the web-based mobile IPTV service, regardless of a service and a network provider. Meanwhile, web technologies having device and platform mobility have to allow users to easily use services from heterogeneous service providers and heterogeneous networks, and have advantages in data processing, representation, and applications. Services which employ no such web technologies may be provided by a limited range of service providers, and these services have limitation in terms of a quality of service, a service area, content, and available applications. Accordingly, if there is no appropriate service according to a user's request, the user has to perform authentication to transfer the request to another service provider. Since such authentication may deteriorate service efficiency of a seamless media streaming service for a mobile user, a mobile IPTV service using a web service platform can improve service efficiency.

Also, the terminal 110 connects to the first service providing apparatus 140 and then transfers a service request signal to the first service providing apparatus 140. At this time, the terminal 110 uses a HyperText Transfer Protocol (HTTP) to transmit the service request signal to the first service providing apparatus 140, wherein the HTTP is a protocol for information reception and transmission on World Wide Web (WWW). The HTTP is used to receive and transmit HyperText Markup Language (HTML) document, and uses a Transmission Control Protocol (TCP) and a User Datagram Protocol (UDP). The HTTP is a request/response protocol that is executed between a client and a server. For example, if a web browser which is a client requests a server to send a web page or image information through the HTTP, the server transfers the requested information to the client in response to the request.

If the terminal 110 receives a handoff execution signal from the first service providing apparatus 140, the terminal 110 is disconnected from the first service providing apparatus 140 and performs handoff to the second service providing apparatus 150. Thereafter, the terminal 110 receives a service response signal corresponding to a service request signal from the second service providing apparatus 150, and also receives service information corresponding to the service request signal from the second service providing apparatus 150.

According to a general communication method, the terminal 110 performs, in order to request service information, a basic call procedure and a security procedure that are provided by the first communication network 120 which is a dedicated network of a specific service provider, and then requests the first service providing apparatus 140 which corresponds to the specific service provider to send the service information, and the first service providing apparatus 140 transfers the requested service information to the terminal 110. In the general communication method, the terminal 110 can request only service information that is provided by a service provider of a network for which the terminal 110 has performed call setting, however, according to an example, a user can receive his or her desired service information through a dedicated network of another service provider for which neither a basic call procedure nor a security procedure have been performed. That is, the terminal 110 requests desired service information on web, instead of requesting desired service information through a service-based user interface that is provided by each service provider. In other words, a web-based service request makes the web-based service providing apparatus 160, as well as a service provider that provides service information to the terminal 110, to participate in provision of the service requested by the terminal 110.

The first communication network 120 is a network allowing data reception and transmission with an Internet protocol using various wired/wireless communication technologies, such as the Internet, the Intranet, a mobile communication network, a satellite communication network, etc. That is, the first communication network 120 includes a proprietary network (for example, a Local Area Network (LAN) and a Wide Area Network (WAN)), an Open network (for example, the Internet), Code Division Multiple Access (CDMA), Wideband Code Division Multiple Access (WCDMA), Global System for Mobile Communications (GSM), Long Term Evolution (LTE), Evolved Packet Core (EPC), a next-generation network, and a cloud computing network. Also, the first communication network 120 may include a cloud computing network that is combined with the first service providing apparatus 140 or the web-based service providing apparatus 160 to store computing resources, such as hardware, software, etc., and provide a client terminal (for example, the terminal 110) with a computing resource requested by the terminal 110. Here, the term “cloud computing” means a computer environment where information is permanently stored in a server on the Internet and temporarily stored in a client terminal, such as a desktop, a table computer, a notebook, a netbook, a smart phone, etc., and the term “cloud computing network” means a computer environment access network where all user information is stored in a server on the Internet to allow various IT devices to use the information anytime anywhere.

The first transmitter 122 is connected to the first communication network 120 to perform all operations for processing wireless calls, such as location registration, wireless channel allocation, handoff, etc., to receive a call request signal from the terminal 110 through a traffic channel among signal channels, and to perform base-band signal processing, wired-wireless conversion, transmission and reception of wireless signals, etc.

The second communication network 130 can receive and transmit data with an Internet protocol using various wired/wireless communication technologies, such as the Internet, the Intranet, a mobile communication network, a satellite communication network, etc. That is, the second communication network 130 includes a proprietary network (for example, LAN and WAN), an Open network (for example, the Internet), CDMA, WCDMA, GSM, LTE, EPC, a next-generation network, and a cloud computing network. Also, the second communication network 130 includes a cloud computing network that is combined with the second service providing apparatus 150 or the web-based service providing apparatus 160 to store computing resources, such as hardware, software, etc., and provide a client terminal (for example, the terminal 110) with a computing resource requested by the terminal 110

The second transmitter 132 is connected to the second communication network 130 to perform all operations for processing wireless calls, such as location registration, wireless channel allocation, handoff, etc., to receive a call request signal from the terminal 110 through a traffic channel among signal channels, and to perform base-band signal processing, wired-wireless conversion, transmission and reception of wireless signals, etc. Here, the second transmitter 132 includes at least one apparatus of a base station that supports a mobile network and an Access Point (AP) that supports an IP network. Also, the AP, which is an apparatus for connecting data communication, reads an address of a reception party from information of a transmission party, designates a most appropriate communication path, and then transmits data to the address of the reception party of another communication network. In other words, the AP extracts a location of a data packet, designates a most appropriate communication path for the extracted location, and transfers the data packet to the next apparatus along the designated communication path, and also can share a plurality of lines in a general network environment. In the current example, the AP may include a router, a repeater, a relay, and a bridge. The AP may support Wireless-Fidelity (Wi-Fi).

The first service providing apparatus 140 is connected to the first communication network 120 and the first transmitter 122 to provide a voice communication service, to provide basic and additional services for processing packet data, to process incoming and outgoing calls of subscribers, to perform a location registration procedure, to perform a handoff procedure, and to perform connections to different networks.

The first service providing apparatus 140 receives a service request signal from the terminal 110 connected thereto. Then, the first service providing apparatus 140 transmits a service providability inquiry signal for service information corresponding to the service request signal to the web-based service providing apparatus 160, based on whether or not the service information can be provided. A process in which the first service providing apparatus 140 determines whether or not service information corresponding to a service request signal can be provided is as follows. If the first service providing apparatus 140 determines that the service information cannot be transmitted to the terminal 110, the first service providing apparatus 140 transmits a service providability inquiry signal to the web-based service providing apparatus 160. That is, if the first service providing apparatus 140 supports no service information corresponding to the service request signal, the first service providing apparatus 140 determines that the service information cannot be transmitted to the terminal 110.

A process in which the first service providing apparatus 140 performs service-based handoff is as follows. The first service providing apparatus 140 transmits control information that has been exchanged with the second service providing apparatus 150 through the web-based service providing apparatus 160, to at least one of the first transmitter 122 and the terminal 110. At this time, the first service providing apparatus 140 transmits the control information to the first transmitter 122 through the first communication network 120 that supports a mobile network. Thereafter, the first service providing apparatus 140 transmits a handoff execution signal to the terminal 110.

An example of the operation of the first service providing apparatus 140 will be described below. When the terminal 110 requests the first service providing apparatus 140 to send service information, the first service providing apparatus 140 provides, if the service information can be provided by the first service providing apparatus 140, the service information to the terminal 110 without help of the web-based service providing apparatus 160. On the contrary, if the first service providing apparatus 140 determines that the service information cannot be provided by the first service providing apparatus 140, that is, if the service information is provided by the second service providing apparatus 150 which is another service provider, the first service providing apparatus 140 performs service-based handoff which is a procedure for changing a service provider in order to provide the service information without ignoring the request from the terminal 110. That is, the first service providing apparatus 140 performs service-based handoff based on the web-based service providing apparatus 160, in order to change a service provider to the second service providing apparatus 150 which is a target service provider as a source service provider.

The second service providing apparatus 150 is connected to the second communication network 130 and the second transmitter 132 to provide a voice communication service, to provide basic and additional services for processing packet data, to process incoming and outgoing calls of subscribers, to perform a location registration procedure, to perform a handoff procedure, and to perform connections to different networks.

The second service providing apparatus 150 receives the service providability inquiry signal from the web-based service providing apparatus 160, and transmits a service providability response signal for the service information to the web-based service providing apparatus 160 based on whether or not the service information can be provided. At this time, a process in which the second service providing apparatus 150 determines whether or not the service information corresponding to the service providability inquiry signal can be provided is as follows. If the service information can be provided, the second service providing apparatus 150 transmits a service providability response signal for the service information to the web-based service providing apparatus 160. Thereafter, the second service providing apparatus 150 is connected to the terminal 110 that has performed handoff, based on control information received from the web-based service providing apparatus 160. The second service providing apparatus 150 exchanges control information for performing handoff of the terminal 110 with the first service providing apparatus 140, transmits the control information to the second transmitter 132, is connected to the terminal 110 that has performed handoff based on the control information, and then transmits a service response signal in response to the service request signal that has been transmitted by the terminal 110. At this time, the second service providing apparatus 150 transmits the service response signal to the terminal 110 using a HTTP.

A process in which the second service providing apparatus 150 performs service-based handoff is as follows. The second service providing apparatus 150 transmits the control information exchanged with the first service providing apparatus 140 through the web-based service providing apparatus 160, to the second transmitter 132. At this time, the second service providing apparatus 150 transmits the control information to the second transmitter 132 through the second communication network 130 that supports a mobile network or an IP network.

The web-based service providing apparatus 160 has the same hardware configuration with a general web server or a network server. However, the web-based service providing apparatus 160 may include a software program module that is implemented with a language, such as C, C++, Java, Visual Basic, Visual C, etc. The web-based service providing apparatus 160 may be implemented as a web server or a network server, and the web server is a computer system connected to a plurality of clients and/or other web servers through an open computer network such as the Internet to receive task execution requests from the clients or the other web servers and obtain the execution results of the tasks, and a computer software (a web server program) installed in the computer system. In addition, the web server has to be interpreted as a broad concept including a series of application programs that operate on the web server and various database established therein.

The web-based service providing apparatus 160 may be implemented with a web server program that is variously provided according to OS, such as DOS, Windows, Linux, UNIX, Macintosh, etc., to general hardware for server. Representative web server programs are CERN, NCSA, APPACH, etc. that are used in the Website IIS (Internet Information Server) and UNIX environment.

Also, the web-based service providing apparatus 160 may be connected to an authentication system and an accounting system when a service for guaranteeing mobility is provided. Also, the web-based service providing apparatus 160 classifies membership information and information about the membership information, stores the classified information in database, and manages it. The database may be implemented inside or outside the web-based service providing apparatus 160. The database means a general data structure implemented in storage (a hard disk or a memory) of a computer system using a database management system (DBMS). The database means a data storage format for freely searching for (extracting), deleting, editing, or adding data. The DMBS includes a Related Database Management System (RDBMS) (for example, Oracle, Infomix, Sybase, DB2), an Object-Oriented Database Management System (OODBMS) (for example, Gemston, Orion, O2) and a XML Native Database (for example, Excelon, Tamino, Sekaiju).

Meanwhile, the web-based service providing apparatus 160 may further include a cloud computing storage and a cloud computing unit for cloud computing. The cloud computing storage includes a storage medium for guaranteeing mobility, and the cloud computing unit allows the terminal 110 to read data from the storage medium or write data in the storage medium.

The web-based service providing apparatus 160 performs a function of managing the first service providing apparatus 140 and the second service providing apparatus 150 and storing/managing services provided by each service provider in the form of metadata. Also, the web-based service providing apparatus 160 functions as a mediator to obtain service information requested by the terminal 110 from service providers and provide the requested service information to the terminal 110. The web-based service providing apparatus 160 performs a function of transmitting the stored metadata in the format of a message to the terminal 110 that uses a service provider in a multicast manner.

The web-based service providing apparatus 160 transmits a service providability inquiry signal to the second service providing apparatus 150 that has been determined to be an apparatus capable of providing service information corresponding to the service providability inquiry signal received from the first service providing apparatus 140, receives a service providability response signal from the second service providing apparatus 150, and then changes a service provider of the terminal 110 from the first service providing apparatus 140 to the second service providing apparatus 150. At this time, the web-based service providing apparatus 160 uses HTTP to receive the service providability inquiry signal from the first service providing apparatus 140 and transmits the service providability inquiry signal to the second service providing apparatus 150. Also, the web-based service providing apparatus 160 uses a HTTP to receive the service providability response signal from the second service providing apparatus 150 and transmit the service providability response signal to the first service providing apparatus 140.

The web-based service providing apparatus 160 receives the service providability response signal from the second service providing apparatus 150 in response to the service providability inquiry signal, transmits the service providability response signal to the first service providing apparatus 140, and obtains control information from the first service providing apparatus 140 to perform handoff between the first service providing apparatus 140 and the second service providing apparatus 150. The control information includes at least one piece of information among parameter information, radio resource information, transmitter information, synchronization information, and security information to perform handoff.

A signal processing method in which the web-based service providing apparatus 160 changes a service provider is as follows. The web-based service providing apparatus 160 transmits a service provider changing signal received from the first service providing apparatus 140 to the second service providing apparatus 150 and then changes a service provider of the terminal 110 from the first service providing apparatus 140 to the second service providing apparatus 150.

The first CP 172, the second CP 174, and the third CP 176 are devices that transmit content information corresponding to specific services to the corresponding service providing apparatuses, respectively. In the current example, the first CP 172 and the second CP 174 are connected to the first service providing apparatus 140, and the third CP 176 is connected to the second service providing apparatus 150. The first CP 172 and the second CP 174 transmit content information corresponding to a service requested by the first service providing apparatus 140 to the first service providing apparatus 140, and the third CP 176 transmits content information corresponding to a service requested by the second service providing apparatus 150 to the second service providing apparatus 150.

If the first service providing apparatus 140 requests the first CP 172 or the second CP 174 to send content information that is provided by the third CP 176, the first CP 172 and the second CP 174 cannot provide the content information, so that the first CP 172 or the second CP 174 transmits a message informing that the first CP 172 and the second CP 174 cannot provide the corresponding content information to the first service providing apparatus 140. In this case, according to an example, the first service providing apparatus 140 transmits a service request signal for the corresponding information to the web-based service providing apparatus 160.

Referring to FIG. 1, the first service providing apparatus 140 provides service information to the terminal 110 through the first communication network (which is in co-relationship with the first service providing apparatus 140) which is a dedicated communication network, and the terminal 110 receives service information belonging to the first service providing apparatus 140. However, if the terminal 110 uses a HTTP to request the first service providing apparatus 140 to send service information that is not supported by the first service providing apparatus 140, the first service providing apparatus 140 requests the web-based service providing apparatus 160 to determine whether or not the corresponding service can be provided, in order to provide the service information requested by the terminal 110. Then, the web-based service providing apparatus 160 checks which service provider can provide the service information requested by the terminal 110 or which web-based service providing apparatus can provide the service information, and transmit information about a service provider or a web-based service providing apparatus that can provide the service information to the first service providing apparatus 140.

Meanwhile, if a service provider that can provide the service information is the second service providing apparatus 150, the second service providing apparatus 150 transmits information (for example, parameter information, radio resource information, base station information, synchronization information, security information, etc., required for handoff call setting) about a second communication network to which the second service providing apparatus 150 belongs, in the form of a message, to the first service providing apparatus 140 through the web-based service providing apparatus 160. At this time, the information provided by the second service providing apparatus 150 is transferred to the terminal 110. The first service providing apparatus 140 transmits information (for example, the state information of the terminal 110, the ID information of the terminal 110, hardware information of the terminal 110, etc.) about the terminal 110 to the second service providing apparatus 150. The second service providing apparatus 150 transfers the information about the terminal 110 to the second transmitter 132 and network managers. The first service providing apparatus 140 changes a service provider of the terminal to the second service providing apparatus 150, and then transmits a handoff execution (start) signal (a message) to the terminal 110. The terminal 110 is disconnected from the first service providing apparatus 140, and performs handoff to the second transmitter 132 and the second communication network 130 based on the information received from the second service providing apparatus 150. After handoff is complete, the second service providing apparatus 150 provides the service information to the terminal 110 based on web.

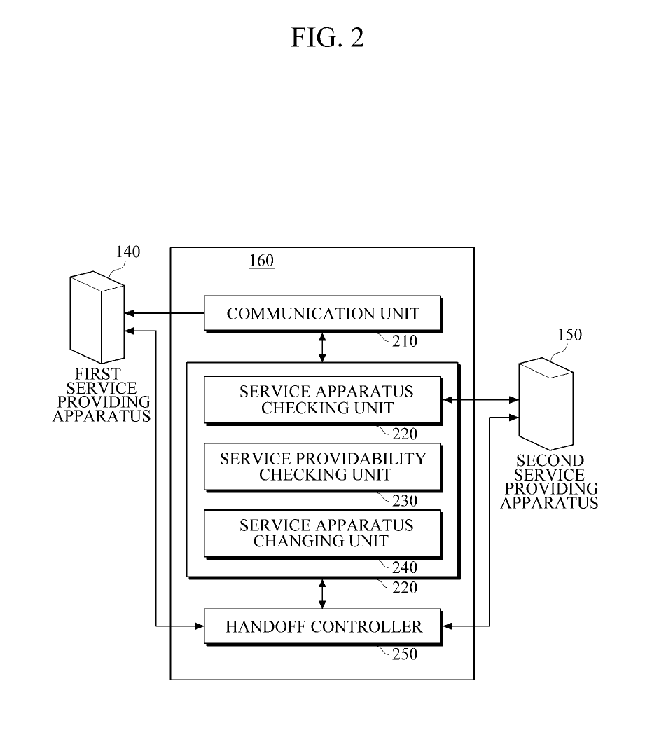

FIG. 2 is a diagram illustrating an example of the web-based service providing apparatus 160.

The web-based service providing apparatus 160 includes a communication unit 210, a service apparatus checking unit 220, a service providability checking unit 230, a service apparatus changing unit 240, and a handoff controller 250. However, the above-mentioned components of the web-based service providing apparatus 160 can be combined in a different manner and/or replaced or supplemented by other components or their equivalents within the scope of the present invention.

Referring to FIGS. 1 and 2, the communication unit 210 is connected to the first service providing apparatus 140 to receive data from the first service providing apparatus 140 and transmit data to the first service providing apparatus 140. The communication unit 210 receives a service providability inquiry signal from the first service providing apparatus 140.

The service apparatus checking unit 220 checks which apparatus can provide service information requested by the terminal 110 in response to the service providability inquiry signal. If the service apparatus checking unit 220 determines that the second service providing apparatus 150 can provide the service information, the service providability checking unit 230 transmits a service providability inquiry signal to the second service providing apparatus 150, and receives a service providability response signal from the second service providing apparatus 150.

The service apparatus changing unit 240 changes a service provider of the terminal 110 from the first service providing apparatus 140 to the second service providing apparatus 150. The handoff controller 250 transmits the service providability response signal to the first service providing apparatus 140, and obtains control information from the first service providing apparatus 140 to perform handoff between the first service providing apparatus 140 and the second service providing apparatus 150.

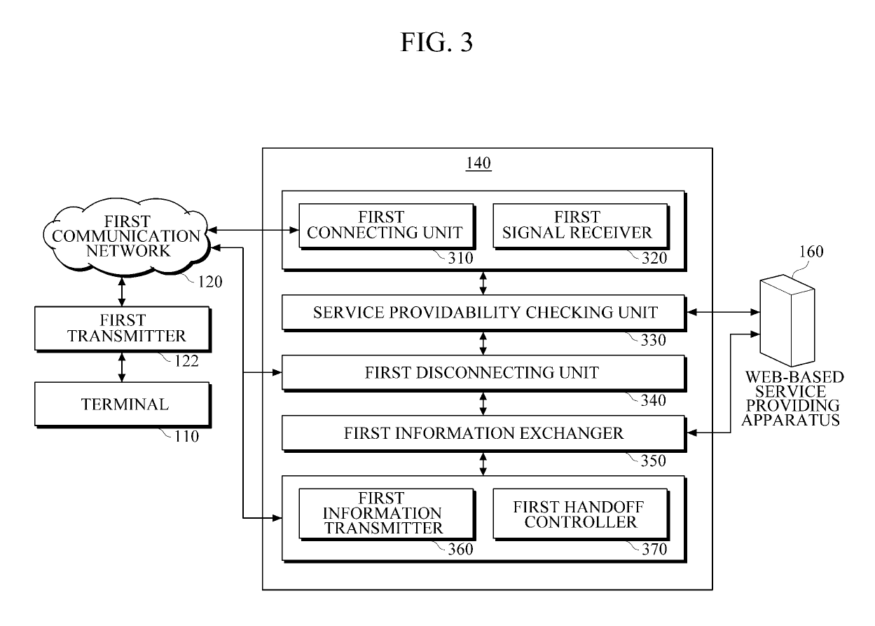

FIG. 3 is a diagram illustrating an example of the first service providing apparatus 140.

The first service providing apparatus 140 includes a first connection unit 310, a first signal receiver 320, a first service providability checking unit 330, a first disconnecting unit 340, a first information exchanger 350, a first information transmitter 360, and a first handoff controller 370. However, the above-mentioned components of the first service providing apparatus 140 can be combined in a different manner and/or replaced or supplemented by other components or their equivalents within the scope of the present invention.

Referring to FIGS. 1 and 3, if the first connection unit 310 is connected to the terminal 110, the first signal receiver 320 receives a service request signal from the terminal 110. Then, the first service providability checking unit 330 transmits a service providability inquiry signal for service information requested by the terminal 110, to the web-based service providing apparatus 160, based on whether or not the service information can be provided, and receives a service providability response signal from the web-based service providing apparatus 160. Also, if the service information cannot be provided, the first service providability checking unit 330 transmits a service providability inquiry signal for the service information to the web-based service providing apparatus 160.

The first disconnecting unit 340 is disconnected from the terminal 110 in response to the service providability response signal. The first information exchanger 350 exchanges control information for performing handoff of the terminal 110 with the second service providing apparatus 150 indicated by the service providability response signal. The first information transmitter 360 transmits the control information received through the first information exchanger 350 to at least one of the first transmitter 122 and the terminal 110. The first handoff controller 370 transmits a handoff execution signal to the terminal 110.

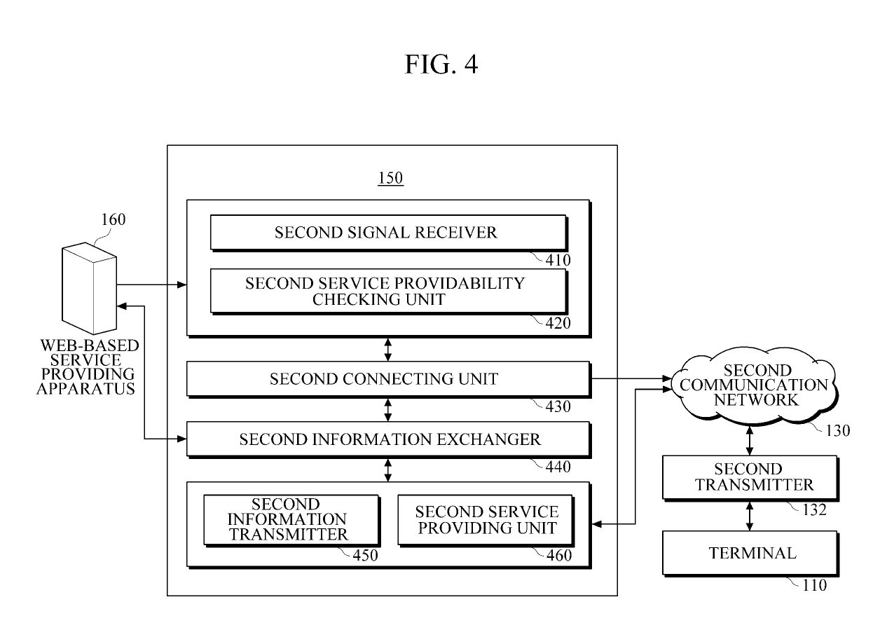

FIG. 4 is a diagram illustrating an example of the second service providing apparatus 150. The second service providing apparatus 150 includes a second signal receiver 410, a second service providability checking unit 420, a second connection unit 430, a second information exchanger 440, a second information transmitter 450, and a second service provider 460. However, the above-mentioned components of the second service providing apparatus 150 can be combined in a different manner and/or replaced or supplemented by other components or their equivalents within the scope of the present invention.

Referring to FIGS. 1 and 4, the second signal receiver 410 receives a service providability inquiry signal from the web-based service providing apparatus 160. The second service providability checking unit 420 transmits a service providability response signal for service information requested by the terminal 110 to the web-based service providing apparatus 160, based on whether or not the service information can be provided. Also, if the service information can be provided, the second service providability checking unit 420 transmits a service providability response signal for the service information to the web-based service providing apparatus 160.

The second connecting unit 430 is connected to the terminal 110 which has performed handoff, based on the control information received from the web-based service providing apparatus 160. The second information exchanger 440 exchanges control information for performing handoff of the terminal 110 with the first service providing apparatus 140. The second information transmitter 450 transmits the control information to the second transmitter 132. The second service provider 460 is connected to the terminal 110 which has performed handoff based on the control information, and transmits a service response signal corresponding to the service request signal transmitted by the terminal 110 to the terminal 110.

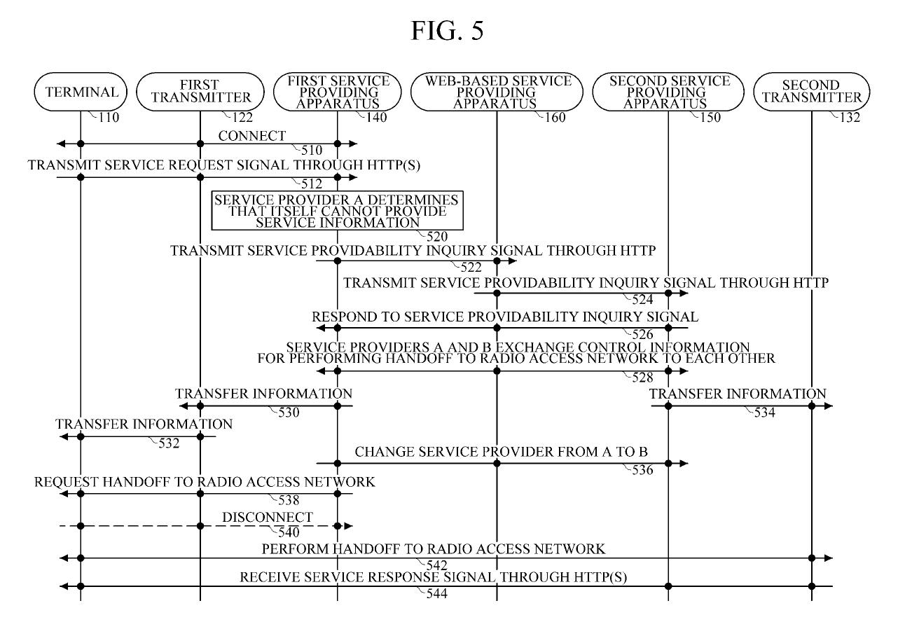

FIG. 5 is a flowchart illustrating an example of a web-based mobility guaranteeing method.

A point denoted by “•” represents operation at which the corresponding apparatus substantially executes the corresponding message. Referring to FIGS. 1 and 5, the terminal 110 is connected to the first service providing apparatus 140 (510), and transmits a service request signal to the first service providing apparatus 140 (512). In operation 512, the terminal 110 uses a HTTP to transmit the service request signal to the first service providing apparatus 140. The first service providing apparatus 140 receives the service request signal from the terminal 110 and determines whether or not service information corresponding to the service request signal can be provided (520). Then, the first service providing apparatus 140 transmits a service providability inquiry signal for the service information to the web-based service providing apparatus 160, based on the result of the determination on whether or not the service information can be provided (522). In operation 522, a process in which the first service providing apparatus 140 determines whether or not service information corresponding to a service request signal can be provided is as follows. If the first service providing apparatus 140 cannot provide the service information to the terminal 110, the first service providing apparatus 140 transmits a service providability inquiry signal to the web-based service providing apparatus 160. That is, if the first service providing apparatus 140 does not support the service information corresponding to the service request signal, the first service providing apparatus 140 determines that the service information cannot be provided to the terminal 110.

If an apparatus that can provide the service information is determined to be the second service providing apparatus 150, the web-based service providing apparatus 160 transmits a service providability inquiry signal to the second service providing apparatus 150 (524). In operation 524, the web-based service providing apparatus 160 uses HTTP to receive a service providability inquiry signal from the first service providing apparatus 40 and transmits the service providability inquiry signal to the second service providing apparatus 150.

The web-based service providing apparatus 160 receives a service providability response signal corresponding to the service providability inquiry signal from the second service providing apparatus 150, and transmits the service providability response signal to the first service providing apparatus 140 (526). In operation 526, the web-based service providing apparatus 160 uses a HTTP to receive the service providability response signal from the second service providing apparatus 150 and transmits the service providability response signal to the first service providing apparatus 140. That is, in order to perform operation 526, the second service providing apparatus 150 receives a service providability inquiry signal from the web-based service providing apparatus 160, and transmits a service providability response signal for the service information to the web-based service providing apparatus 160, based on whether or not the service information corresponding to the service providability inquiry signal can be provided. A process in which the second service providing apparatus 150 determines whether or not the service information can be provided is as follows. The second service providing apparatus 150 transmits, if the service information can be provided, a service providability response signal for the service information to the web-based service providing apparatus 160.

The web-based service providing apparatus 160 exchanges control information for performing handoff between the first service providing apparatus 140 and the second service providing apparatus 150 (528). Here, the control information includes at least one piece of information among parameter information, radio resource information, transmitter information, synchronization information, and security information, required for performing handoff.

The first service providing apparatus 140 transmits the control information exchanged with the second service providing apparatus 150 through the web-based service providing apparatus 160, to the first transmitter 122 (530). In operation 530, the first service providing apparatus 140 transmits the control information to the first transmitter 122 through the first communication network 120 that supports a mobile network. The first transmitter 122 transmits control information received from the first service providing apparatus 140 to the terminal 110 (532).

The second service providing apparatus 150 exchanges control information for performing handoff of the terminal 110 with the first service providing apparatus 140, and transmits the control information to the second transmitter 132 (534). In more detail, in operation 534, the second service providing apparatus 150 transmits the control information exchanged with the first service providing apparatus 140 to the second transmitter 132 through the web-based service providing apparatus 160. At this time, the second service providing apparatus 150 transmits the control information to the second transmitter 132 through the second communication network 130 that supports a mobile network or an IP network.

The web-based service providing apparatus 160 transmits a service provider changing signal received from the first service providing apparatus 140 to the second service providing apparatus 150, and then changes a service provider of the terminal 110 from the first service providing apparatus 140 to the second service providing apparatus 150 (536).

The first service providing apparatus 140 transmits a handoff execution signal to the terminal 110 (538). When the terminal 110 receives the handoff execution signal from the first service providing apparatus 140, the terminal 110 is disconnected from the first service providing apparatus 140, and performs handoff to the second service providing apparatus 150 (542). In operation 542, the second service providing apparatus 150 is connected to the terminal 110 which has preformed handoff based on the control information received from the web-based service providing apparatus 160.

The terminal 110 receives a service response signal corresponding to the service request signal from the second service providing apparatus 150, and receives service information corresponding to the service request signal from the second service providing apparatus 150 (544). In operation 544, the second service providing apparatus 150 is connected to the terminal 110 which has performed handoff based on the control information, and transmits a service response signal corresponding to the service request signal transmitted by the terminal 110 to the terminal 110. At this time, the second service providing apparatus 150 uses a HTTP to transmit the service response signal to the terminal 110.

Meanwhile, service-based handoff includes all operations (512 through 544) required for changing a service provider, as well as an access network handoff procedure as shown in FIG. 5. The service-based handoff guarantees web-based mobility capable of providing all service information provided by individual service providers to the terminal, without providing a limited communication space provided by service providers in which the terminal 110 has been registered, to the terminal 110.

FIG. 5 shows the case where operations 510 through 544 are sequentially executed, however, this is only exemplary. In other words, a person having ordinary skill in the art may change the execution order of operations 510 through 544 or execute one or more of operations 510 through 544 in parallel within the scope of the present invention.

As described above, according to an aspect, it is possible to provide service information requested on web by a user to the user's terminal, regardless of a service provider and a dedicated network, instead of providing the user's terminal with only limited service information from a service provider in which the user's terminal has been registered. Also, according to another aspect, it is possible to perform service-based handoff, thereby guaranteeing web-based mobility.

In addition, according to another aspect, instead of being dependent on a network for which a terminal has performed call setting and receiving only service information provided from a service provider of the network, the terminal can receive a user's desired service information through dedicated networks of other service providers for which the terminal has performed neither a basic call procedure nor a security/authentication procedure.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A web-based mobility guaranteeing method comprising:
at a terminal, connecting to a first service providing apparatus;
at the terminal, transmitting a service request signal for requesting service information to the first service providing apparatus;
at the first service providing apparatus, transmitting a service providability inquiry signal to a web-based service providing apparatus, based on whether or not the service information is able to be provided by the first service providing apparatus;
at the web-based service providing apparatus, transmitting the service providability inquiry signal to a second service providing apparatus that is determined to be an apparatus capable of providing the service information, receiving a service providability response signal from the second service providing apparatus, and then changing a service provider of the terminal from the first service providing apparatus to the second service providing apparatus; and
at the terminal, receiving a service response signal from the second service providing apparatus in response to the service request signal.

2. The web-based mobility guaranteeing method of claim 1, further comprising:
at the web-based service providing apparatus, transmitting the service providability response signal received from the second service providing apparatus to the first service providing apparatus; and
at the web-based service providing apparatus, exchanging control information for performing handoff between the first service providing apparatus and the second service providing apparatus.

3. The web-based mobility guaranteeing method of claim 2, wherein the control information includes at least one piece of information among parameter information, radio resource information, transmitter information, synchronization information, and security information, required for performing handoff.

4. The web-based mobility guaranteeing method of claim 2, further comprising:
at the first service providing apparatus, transmitting the control information to at least one of a first transmitter and the terminal; and
at the second service providing apparatus, transmitting the control information to a second transmitter.

5. The web-based mobility guaranteeing method of claim 4, wherein the first service providing apparatus transmits the control information to the first transmitter through a first communication network which supports a mobile network.

6. The web-based mobility guaranteeing method of claim 4, wherein the second service providing apparatus transmits the control information to the second transmitter through a second communication network which supports a mobile network or an IP network.

7. The web-based mobility guaranteeing method of claim 6, wherein the second transmitter includes at least one of a base station which supports the mobile network and an Access Point (AP) which supports the IP network.

8. The web-based mobility guaranteeing method of claim 4, wherein the web-based service providing apparatus transmits a service provider changing signal received from the first service providing apparatus to the second service providing apparatus to thereby change the service provider of the terminal from the first service providing apparatus to the second service providing apparatus.

9. The web-based mobility guaranteeing method of claim 4, further comprising:
at the first service providing apparatus, transmitting a handoff execution signal to the terminal;
at the terminal, being disconnected from the first service providing apparatus; and
at the terminal, performing handoff to the second service providing apparatus.

10. The web-based mobility guaranteeing method of claim 1, further comprising at the terminal, receiving the service information from the second service providing apparatus.

11. The web-based mobility guaranteeing method of claim 1, wherein the first service providing apparatus transmits, if determining that the service information is disable to be transmitted to the terminal, the service providability inquiry signal to the web-based service providing apparatus.

12. The web-based mobility guaranteeing method of claim 11, wherein the first service providing apparatus determines, if the first service providing apparatus does not support the service information, that the service information is disable to be transmitted to the terminal.

13. The web-based mobility guaranteeing method of claim 1, wherein the terminal is a terminal that supports a mobile Internet Protocol Television (IPTV).

14. The web-based mobility guaranteeing method of claim 1, wherein the terminal uses a HyperText Transfer Protocol (HTTP) to transmit the service request signal to the first service providing apparatus.

15. The web-based mobility guaranteeing method of claim 1, wherein the web-based service providing apparatus uses a HyperText Transfer Protocol (HTTP) to receive the service providability inquiry signal from the first service providing apparatus and transmit the service providability inquiry signal to the second service providing apparatus.

16. A web-based service providing apparatus comprising:
a communication unit configured to receive a service providability inquiry signal from a first service providing apparatus;
a service apparatus checking unit configured to determine which apparatus is able to provide service information corresponding to the service providability inquiry signal;
a service providability checking unit configured to transmit the service providability inquiry signal to a second service providability apparatus that is determined to be an apparatus capable of providing the service information, and to receive a service providability response signal from the second service providing apparatus in response to the service providability inquiry signal; and
a service apparatus changing unit configured to change a service provider of the terminal from the first service providing apparatus to the second service providing apparatus.

17. The web-based service providing apparatus of claim 16, further comprising a handoff controller configured to transmit the service providability response signal to the first service providing apparatus, and to exchange control information for performing handoff between the first service providing apparatus and the second service providing apparatus.

18. A service providing apparatus comprising:
a first connecting unit configured to connect to a terminal;
a first signal receiver configured to receive a service request signal for requesting service information from the terminal;
a first service providability checking unit configured to transmit a service providability inquiry signal to a web-based service providing apparatus, based on whether or not the service information is able to be provided, and to receive a service providability response signal from the web-based service providing apparatus in response to the service providability inquiry signal; and
a first disconnecting unit configured to be disconnected from the terminal according to the service providability response signal.

19. The service providing apparatus of claim 18, comprising:
a first information exchanger configured to exchange control information for performing handoff with a second service providing apparatus indicated by the service providability response signal;
a first information transmitter configured to transmit the control information to at least one of the first transmitter and the terminal; and
a first handoff controller configured to transmit a handoff execution signal to the terminal.

20. The service providing apparatus of claim 18, wherein the first service providability checking unit transmits, if the service information is disable to be provided, the service providability inquiry signal to the web-based service providing apparatus.
